(19) United States
(12) Patent Application Publication
(10) Pub. No.: US 2026/0079140 A1
(43) Pub. Date: Mar. 19, 2026

(54) Reducing Data Complexity for Subsequent RT Alignment

(71) Applicant: DH Technologies Development Pte. Ltd., Singapore (SG)

(72) Inventors: Lyle Lorrence BURTON, Woodbridge (CA); David Michael COX, Toronto (CA)

(21) Appl. No.: 19/118,426

(22) PCT Filed: Oct. 5, 2023
(86) PCT No.: PCT/IB2023/060014

§ 371 Date: Apr. 4, 2025

Related U.S. Application Data
(60) Provisional application No. 63/378,659, filed on Oct. 6, 2022.

(51) Int. Cl. G01N 30/86; G01N 30/72

(52) U.S. Cl. CPC G01N 30/8631; G01N 30/72

(57) ABSTRACT

A first analysis of a mass range of a first sample is performed using a separation coupled mass spectrometer, producing a first set of multivariate data that includes both retention time and mass spectral data. A second analysis of a mass range of a second sample is performed using a separation coupled mass spectrometer, producing a second set of multivariate data that includes both retention time and mass spectral data. Each of the first set and the second set is divided into two or more subsets corresponding to two or m/z sub-ranges of the mass range. One or more chromatographic peaks in each of the two or more subsets of the first set are independently aligned with one or more chromatographic peaks in each corresponding subset of the two or more subsets of the second set using an alignment method.

### RELATED APPLICATIONS

This application claims the benefit of U.S. Provisional Patent Application Ser. No. 63/378,659, filed on Oct. 6, 2022, the content of which is incorporated by reference herein in its entirety.

### INTRODUCTION

The teachings herein relate to aligning the chromatographic peaks of separate experiments. More particularly the teachings herein relate to systems and methods for dividing multivariate data from each of at least two different experiments into two or more mass-to-charge (m/z) sub-ranges of the mass range and independently aligning chromatographic peaks in the sub-ranges using an alignment method.

The systems and methods herein can be performed in conjunction with a processor, controller, or computer system, such as the computer system of FIG. 1.

### Chromatographic Peak Alignment Problem

Since chromatographic peaks are subject to drift from run to run, it is common practice to “align” the liquid chromatography (LC) dimension between two liquid chromatography coupled mass spectrometry (LC/MS) runs being compared. An alignment method known as dynamic time warping (DTW) has been used for aligning peaks of two similar samples.

DTW produces a non-linear alignment (e.g., peaks near the end of the run may be shifted more or less than near the start). However, it shifts all peaks at any specific retention time by the same amount. One limitation of DTW has been that some peaks shift differently from others in the immediate retention time vicinity. The exact reason is not understood and it seems that this is most prevalent for peptides compared to small molecules.

Smith et al., LC-MS alignment in theory and practice: a comprehensive algorithmic review, briefings in bioinformatics, vol. 16, pages 104-117, 2013, have reviewed the use of warping methods in chromatographic peak alignment.

They find a similar problem with warping methods in general. They describe that some alignment shifts are common to the whole run, which they refer to as system-level variations. Such shifts can be modeled using monotonic functions, such as warping functions. However, they provide that most shifts are component-level variations rather than system-level variations. These types of “variations are singularities specific to a single analyte or group of related analytes” and “cannot be modeled using monotonic functions.” As a result, the authors teach away from using monotonic alignment methods, such as warping methods.

As a result, additional systems and methods are needed to align chromatographic peaks between LC/MS runs, particularly when peak variation is specific to a single analyte or group of related analytes.

### LC-MS and LC-MS/MS Background

Mass spectrometry (MS) is an analytical technique for the detection and quantitation of chemical compounds based on the analysis of mass-to-charge ratios (m/z) of ions formed from those compounds. The combination of mass spectrometry (MS) and liquid chromatography (LC) is an important analytical tool for the identification and quantitation of compounds within a mixture. Generally, in liquid chromatography, a fluid sample under analysis is passed through a column filled with a chemically-treated solid adsorbent material (typically in the form of small solid particles, e.g., silica). Due to slightly different interactions of components of the mixture with the solid adsorbent material (typically referred to as the stationary phase), the different components can have different transit (elution) times through the packed column, resulting in separation of the various components.

Note that the terms “mass” and “m/z” are used interchangeably herein. One of ordinary skill in the art understands that a mass can be found from an m/z by multiplying the m/z by the charge. Similarly, the m/z can be found from a mass by dividing the mass by the charge.

In LC-MS, the effluent exiting the LC column can be continuously subjected to MS analysis. The data from this analysis can be processed to generate an extracted ion chromatogram (XIC), which can depict detected ion intensity (a measure of the number of detected ions of one or more particular analytes) as a function of retention time.

In MS analysis, an MS or precursor ion scan is performed at each interval of the separation for a mass range that includes the precursor ion. An MS scan includes the selection of a precursor ion or precursor ion range and mass analysis of the precursor ion or precursor ion range.

In some cases, the LC effluent can be subjected to tandem mass spectrometry (or mass spectrometry/mass spectrometry MS/MS) for the identification of product ions corresponding to the peaks in the XIC. For example, the precursor ions can be selected based on their mass/charge ratio to be subjected to subsequent stages of mass analysis. For example, the selected precursor ions can be fragmented (e.g., via collision-induced dissociation), and the fragmented ions (product ions) can be analyzed via a subsequent stage of mass spectrometry.

### Fragmentation Techniques Background

Electron-based dissociation (ExD), ultraviolet photodissociation (UVPD), infrared photodissociation (IRMPD), and collision-induced dissociation (CID) are often used as fragmentation techniques for tandem mass spectrometry (MS/MS). CID is the most conventional technique for dissociation in tandem mass spectrometers.

ExD can include, but is not limited to, electron-induced dissociation (EID), electron impact excitation in organics (EIEIO), electron capture dissociation (ECD), or electron transfer dissociation (ETD).

### Tandem Mass Spectrometry or MS/MS Background

Tandem mass spectrometry or MS/MS involves ionization of one or more compounds of interest from a sample, selection of one or more precursor ions of the one or more compounds, fragmentation of the one or more precursor ions into product ions, and mass analysis of the product ions.

Tandem mass spectrometry can provide both qualitative and quantitative information. The product ion spectrum can be used to identify a molecule of interest. The intensity of one or more product ions can be used to quantitate the amount of the compound present in a sample.

A large number of different types of experimental methods or workflows can be performed using a tandem mass spectrometer. These workflows can include, but are not limited to, targeted acquisition, information dependent acquisition (IDA) or data dependent acquisition (DDA), and data independent acquisition (DIA).

In a targeted acquisition method, one or more transitions of a precursor ion to a product ion are predefined for a compound of interest. As a sample is being introduced into the tandem mass spectrometer, the one or more transitions are interrogated during each time period or cycle of a plurality of time periods or cycles. In other words, the mass spectrometer selects and fragments the precursor ion of each transition and performs a targeted mass analysis for the product ion of the transition. As a result, a chromatogram (the variation of the intensity with retention time) is produced for each transition. Targeted acquisition methods include, but are not limited to, multiple reaction monitoring (MRM) and selected reaction monitoring (SRM).

MRM experiments are typically performed using “low resolution” instruments that include, but are not limited to, triple quadrupole (QqQ) or quadrupole linear ion trap (QqLIT) devices. With the advent of “high resolution” instruments, there was a desire to collect MS and MS/MS using workflows that are similar to QqQ/QqLIT systems. High-resolution instruments include, but are not limited to, quadrupole time-of-flight (QqTOF) or orbitrap devices. These high-resolution instruments also provide new functionality.

MRM on QqQ/QqLIT systems is the standard mass spectrometric technique of choice for targeted quantification in all application areas, due to its ability to provide the highest specificity and sensitivity for the detection of specific components in complex mixtures. However, the speed and sensitivity of today's accurate mass systems have enabled a new quantification strategy with similar performance characteristics. In this strategy (termed MRM high resolution (MRM-HR) or parallel reaction monitoring (PRM)), looped MS/MS spectra are collected at high-resolution with short accumulation times, and then fragment ions (product ions) are extracted post-acquisition to generate MRM-like peaks for integration and quantification. With instrumentation like the TRIPLETOF® Systems of AB SCIEX™, this targeted technique is sensitive and fast enough to enable quantitative performance similar to higher-end triple quadrupole instruments, with full fragmentation data measured at high resolution and high mass accuracy.

In other words, in methods such as MRM-HR, a high-resolution precursor ion mass spectrum is obtained, one or more precursor ions are selected and fragmented, and a high-resolution full product ion spectrum is obtained for each selected precursor ion. A full product ion spectrum is collected for each selected precursor ion but a product ion mass of interest can be specified and everything other than the mass window of the product ion mass of interest can be discarded.

In an IDA (or DDA) method, a user can specify criteria for collecting mass spectra of product ions while a sample is being introduced into the tandem mass spectrometer. For example, in an IDA method a precursor ion or mass spectrometry (MS) survey scan is performed to generate a precursor ion peak list. The user can select criteria to filter the peak list for a subset of the precursor ions on the peak list. The survey scan and peak list are periodically refreshed or updated, and MS/MS is then performed on each precursor ion of the subset of precursor ions. A product ion spectrum is produced for each precursor ion.

MS/MS is repeatedly performed on the precursor ions of the subset of precursor ions as the sample is being introduced into the tandem mass spectrometer.

In proteomics and many other applications, however, the complexity and dynamic range of compounds is very large. This poses challenges for traditional targeted and IDA methods, requiring very high-speed MS/MS acquisition to deeply interrogate the sample in order to both identify and quantify a broad range of analytes.

As a result, DIA methods, the third broad category of tandem mass spectrometry, were developed. These DIA methods have been used to increase the reproducibility and comprehensiveness of data collection from complex samples. DIA methods can also be called non-specific fragmentation methods. In a DIA method the actions of the tandem mass spectrometer are not varied among MS/MS scans based on data acquired in a previous precursor or survey scan. Instead, a precursor ion mass range is selected. A precursor ion mass selection window is then stepped across the precursor ion mass range. All precursor ions in the precursor ion mass selection window are fragmented and all of the product ions of all of the precursor ions in the precursor ion mass selection window are mass analyzed.

The precursor ion mass selection window used to scan the mass range can be narrow so that the likelihood of multiple precursors within the window is small. This type of DIA method is called, for example, MS/MS^{ALL}. In an MS/MS^{ALL} method, a precursor ion mass selection window of about 1 Da is scanned or stepped across an entire mass range. A product ion spectrum is produced for each 1 Da precursor mass window. The time it takes to analyze or scan the entire mass range once is referred to as one scan cycle. Scanning a narrow precursor ion mass selection window across a wide precursor ion mass range during each cycle, however, can take a long time and is not practical for some instruments and experiments.

As a result, a larger precursor ion mass selection window, or selection window with a greater width, is stepped across the entire precursor mass range. This type of DIA method is called, for example, SWATH acquisition. In a SWATH acquisition, the precursor ion mass selection window stepped across the precursor mass range in each cycle may have a width of 5-25 Da, or even larger. Like the MS/MS^{ALL} method, all of the precursor ions in each precursor ion mass selection window are fragmented, and all of the product ions of all of the precursor ions in each mass selection window are mass analyzed. However, because a wider precursor ion mass selection window is used, the cycle time can be significantly reduced in comparison to the cycle time of the MS/MS^{ALL} method.

U.S. Pat. No. 8,809,770 describes how SWATH acquisition can be used to provide quantitative and qualitative information about the precursor ions of compounds of interest. In particular, the product ions found from fragmenting a precursor ion mass selection window are compared to a database of known product ions of compounds of interest. In addition, ion traces or extracted ion chromatograms (XICs) of the product ions found from fragmenting a precursor ion mass selection window are analyzed to provide quantitative and qualitative information.

However, identifying compounds of interest in a sample analyzed using SWATH acquisition, for example, can be difficult. It can be difficult because either there is no precursor ion information provided with a precursor ion mass selection window to help determine the precursor ion that produces each product ion, or the precursor ion information provided is from a mass spectrometry (MS) observation that has a low sensitivity. In addition, because there is little or no specific precursor ion information provided with a precursor ion mass selection window, it is also difficult to determine if a product ion is convolved with or includes contributions from multiple precursor ions within the precursor ion mass selection window.

As a result, a method of scanning the precursor ion mass selection windows in SWATH acquisition, called scanning SWATH, was developed. Essentially, in scanning SWATH, a precursor ion mass selection window is scanned across a mass range so that successive windows have large areas of overlap and small areas of non-overlap. This scanning makes the resulting product ions a function of the scanned precursor ion mass selection windows. This additional information, in turn, can be used to identify the one or more precursor ions responsible for each product ion.

Scanning SWATH has been described in International Publication No. WO 2013/171459 A2 (hereinafter “the '459 Application”). In the '459 Application, a precursor ion mass selection window or precursor ion mass selection window of 25 Da is scanned with time such that the range of the precursor ion mass selection window changes with time. The timing at which product ions are detected is then correlated to the timing of the precursor ion mass selection window in which their precursor ions were transmitted.

The correlation is done by first plotting the mass-to-charge ratio (m/z) of each product ion detected as a function of the precursor ion m/z values transmitted by the quadrupole mass filter. Since the precursor ion mass selection window is scanned over time, the precursor ion m/z values transmitted by the quadrupole mass filter can also be thought of as times. The start and end times at which a particular product ion is detected are correlated to the start and end times at which its precursor is transmitted from the quadrupole. As a result, the start and end times of the product ion signals are used to determine the start and end times of their corresponding precursor ions.

### SUMMARY

A system, method, and computer program product are disclosed for aligning chromatographic peaks of separate experiments that were generated in a separation coupled mass spectrometer. The system can include processor.

In some embodiments, the separation coupled mass spectrometer performs a first analysis of a mass range of a first sample. A first set of multivariate data that includes both retention time and mass spectral data is produced. The separation coupled mass spectrometer performs a second analysis of the same mass range of a second sample. A second set of multivariate data that includes both retention time and mass spectral data is produced.

The processor divides each of the first set and the second set into two or more subsets corresponding to two or more m/z sub-ranges of the mass range. Finally, the processor aligns one or more chromatographic peaks in each of the two or more subsets of the first set with one or more chromatographic peaks in each corresponding subset of the two or more subsets of the second set using an alignment method.

In some embodiments, a method for aligning chromatographic peaks of separate experiments is described. The method comprising: obtaining results of a first analysis of a mass range of a first sample generated from a separation coupled mass spectrometer, producing a first set of multivariate data that includes both retention time and mass spectral data; obtaining results of a second analysis of the mass range of a second sample generated from the separation coupled mass spectrometer, producing a second set of multivariate data that includes both retention time and mass spectral data; dividing each of the first set and the second set into two or more subsets corresponding to two or more mass-to-charge (m/z) sub-ranges of the mass range; and independently aligning one or more chromatographic peaks in each of the two or more subsets of the first set with one or more chromatographic peaks in each corresponding subset of the two or more subsets of the second set using an alignment method.

In some embodiments, a computer program product, comprising a non-transitory tangible computer-readable storage medium whose contents cause a processor to perform a method for aligning chromatographic peaks of separate experiments is described, the method comprising: providing a system, wherein the system comprises one or more distinct software modules, and wherein the distinct software modules comprise an analysis module; obtaining results of a first analysis of a mass range of a first sample using the analysis module, the results of the first analysis of the mass range having a first set of multivariate data that includes both retention time and mass spectral data; obtaining results a second analysis of the mass range of a second sample using the analysis module, the results of the second analysis of the mass rang having a second set of multivariate data that includes both retention time and mass spectral data; dividing each of the first set and the second set into two or more subsets corresponding to two or more mass-to-charge (m/z) sub-ranges of the mass range using the analysis module; and independently aligning one or more chromatographic peaks in each of the two or more subsets of the first set with one or more chromatographic peaks in each corresponding subset of the two or more subsets of the second set using an alignment method using the analysis module.

In some embodiments, a system for identifying an unknown compound is described. The system comprising: a processor that obtains results of a first analysis of a mass range of a first sample, having a first set of multivariate data that includes both retention time and mass spectral data; obtains results of a second analysis of the mass range of a second sample, having a second set of multivariate data that includes both retention time and mass spectral data; divides each of the first set and the second set into two or more subsets corresponding to two or more mass-to-charge (m/z) sub-ranges of the mass range and independently aligns one or more chromatographic peaks in each of the two or more subsets of the first set with one or more chromatographic peaks in each corresponding subset of the two or more subsets of the second set using an alignment method.

These and other features of the applicant's teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary plot showing how multivariate data is divided into separate windows, in accordance with various embodiments.

FIG. 3 is a schematic diagram of a system for aligning chromatographic peaks of separate experiments, in accordance with various embodiments.

FIG. 4 is an exemplary flowchart showing a method for aligning chromatographic peaks of separate experiments, in accordance with various embodiments.

FIG. 5 is a schematic diagram of a system that includes one or more distinct software modules and that performs a method for providing a user interface for aligning chromatographic peaks of separate experiments, in accordance with various embodiments.

FIG. 6 is an exemplary plot of the total ion chromatograms (TICs) from two replicate SWATH experiments without separating the multivariate data by SWATH before aligning the chromatographic peaks using the DTW method, in accordance with various embodiments.

FIG. 7 is an exemplary plot of the TICs from two replicate SWATH experiments where the multivariate data is separated by SWATH before aligning the chromatographic peaks using the DTW method, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

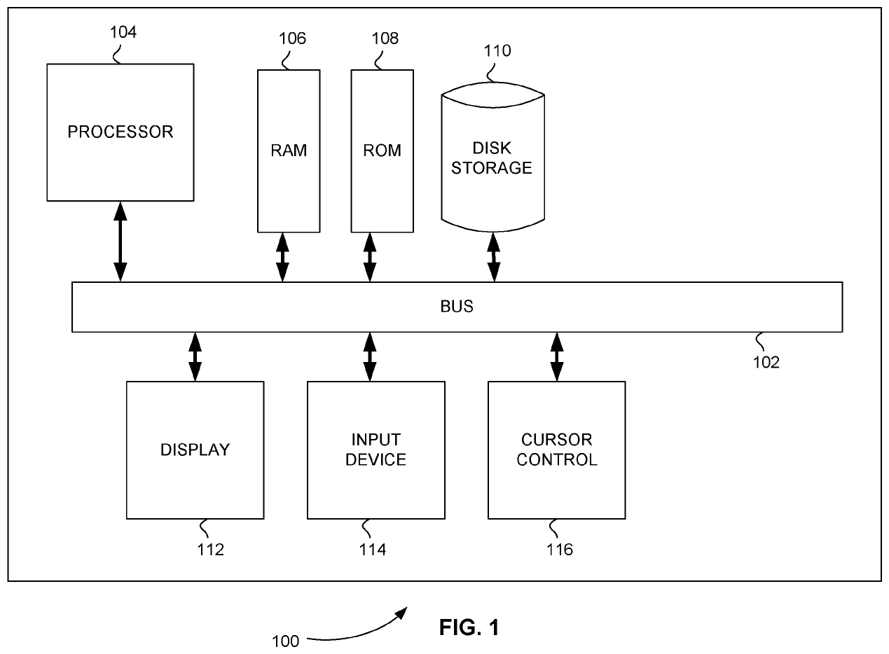

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random-access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein.

Alternatively, hard-wired circuitry may be used in place of or in combination with software instructions to implement the present teachings. For example, the present teachings may also be implemented with programmable artificial intelligence (AI) chips with only the encoder neural network programmed-to allow for performance and decreased cost. Thus, implementations of the present teachings are not limited to any specific combination of hardware circuitry and software.

The term “computer-readable medium” or “computer program product” as used herein refers to any media that participates in providing instructions to processor 104 for execution. The terms “computer-readable medium” and “computer program product”are used interchangeably throughout this written description. Such a medium may take many forms, including but not limited to, non-volatile media and volatile media. Non-volatile media includes, for example, optical or magnetic disks, such as storage device 110. Volatile media includes dynamic memory, such as memory 106.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Aligning Chromatographic Peaks By M/Z Sub-Ranges

As described above, chromatographic peaks are subject to drift from run-to-run requiring alignment of peaks of two similar samples. Dynamic time warping (DTW) has been used for aligning peaks of two similar samples. However, one limitation of DTW has been that some peaks shift differently from others in the immediate retention time vicinity.

A similar problem has been found with warping methods in general. Warping methods are monotonic functions. Monotonic functions are not well suited to model variations that are due to singularities specific to a single analyte or group of related analytes.

As a result, additional systems and methods are needed to align chromatographic peaks between LC/MS runs, particularly when peak variation is specific to a single analyte or group of related analytes.

In various embodiments, chromatographic peaks are aligned between LC/MS runs even with peak variations that are specific to a single analyte or group of related analytes by splitting the LC/MS runs into different “pieces.” A conventional alignment method, such as DTW, is then applied to each piece separately.

As described above, a number of mass spectrometry techniques are available that can provide multivariate data. Multivariate data includes, for example, mass spectral intensity and m/z values for each retention time (RT). One embodiment is then to divide the multivariate data into separate m/z windows and perform a multivariate DTW alignment on each window (for the multivariate algorithm, the m/z window is split into smaller m/z sub-range XICs).

When aligning a feature of a given m/z between two samples, the DTW result from the corresponding window containing that specific m/z is used. This approach is more successful in allowing peaks with similar retention times to shift differently from their neighbors since it is less likely that both will be in the same m/z window (although still possible). One disadvantage of this scheme is that a particular compound and its adducts or in-source fragments (and even isotopes) can be shifted by different amounts.

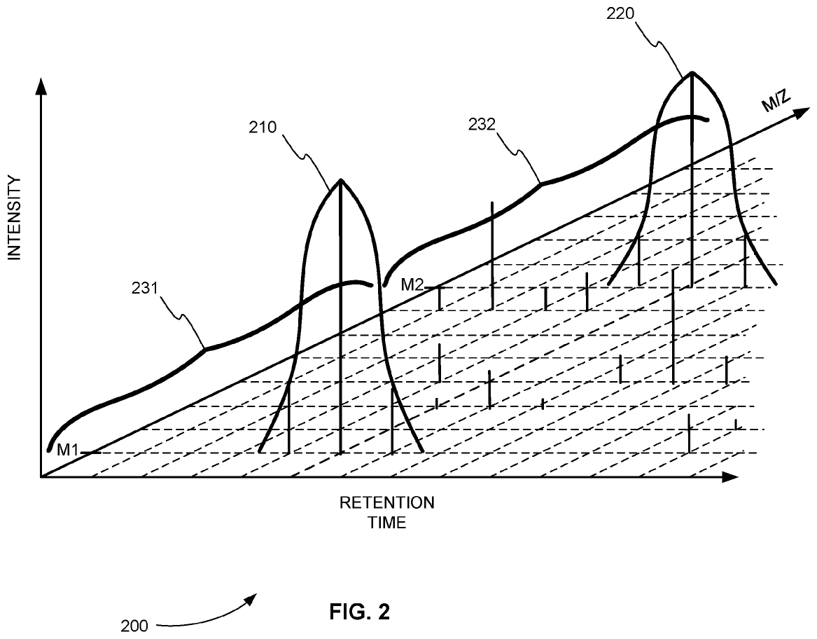

FIG. 2 is an exemplary plot 200 showing how multivariate data is divided into separate windows, in accordance with various embodiments. In plot 200, intensity peaks are plotted with respect to m/z and time. This is the multivariate data. Two chromatographic peaks 210 and 220 for two different m/z values M1 and M2, respectively, are additionally shown in plot 200.

When aligning a feature of a given m/z between two samples the multivariate data is divided into separate m/z windows. In plot 200, the multivariate data is divided into m/z window 231 and m/z window 232, for example. Window 231 includes intensities for m/z value M1 and window 232 includes intensities for m/z value M2.

Chromatographic peaks 210 and 220 have similar retention times but very different m/z values. Separating peaks 210 and 220 into different m/z windows allows an alignment method, such as DTW, to be performed independently on each of peaks 210 and 220 and their corresponding peaks obtained from a different LC/MS run. Because peaks 210 and 220 are separate analytes, applying the alignment method to each of them independently allows for a variation or shift that is specific to each analyte to be found.

In various embodiments, precursor ion chromatographic peaks are separated into different precursor ion m/z windows. Similarly, in various embodiments, product ion chromatographic peaks are separated into different product ion m/z windows.

In another embodiment, chromatographic peaks of two SWATH runs are aligned by aligning each MS/MS SWATH (or precursor ion transmission window) separately. Again, this is a multivariate alignment using multiple XICs covering the mass range for each SWATH. This approach aligns peaks with similar RTs but with different shifts since it is less likely that both peaks are in the same SWATH (or precursor ion transmission window) (although still possible for sufficiently complex samples).

In this embodiment, product ion chromatographic peaks are separated into different precursor ion m/z windows. Additionally, this embodiment has the advantage that all product ions for a given precursor are aligned identically.

### System for Aligning Chromatographic Peaks of Separate Experiments

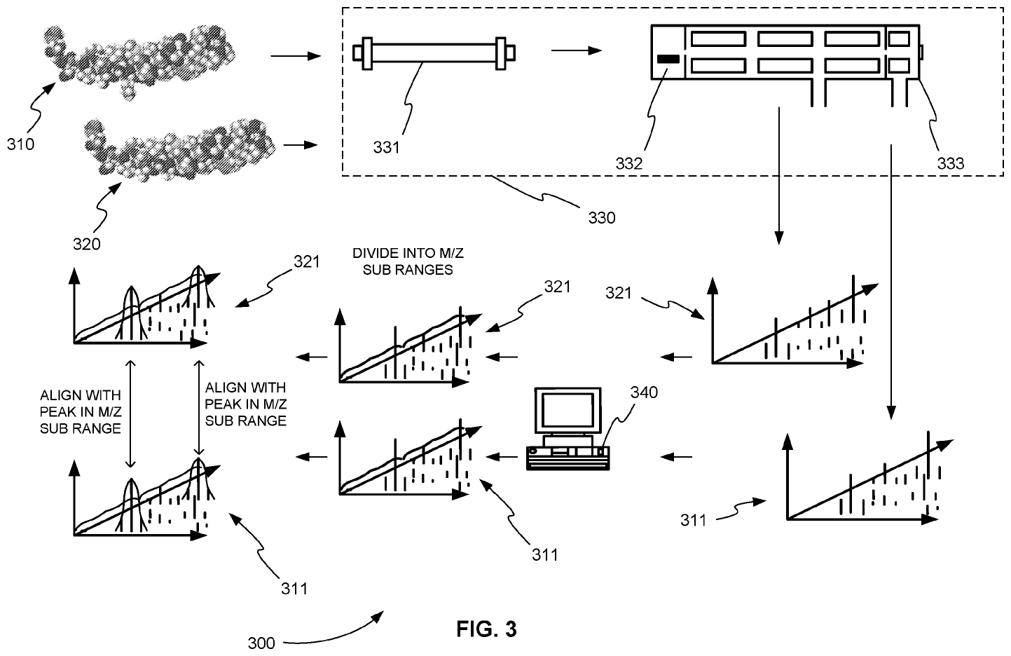

FIG. 3 is a schematic diagram 300 of a system for aligning chromatographic peaks of separate experiments, in accordance with various embodiments. The system can include separation coupled mass spectrometer 330 and processor 340.

Separation coupled mass spectrometer 330 performs a first analysis of a mass range of a first sample 310 and generates results. First set of multivariate data 311 that includes both retention time and mass spectral data is produced. Separation coupled mass spectrometer 330 performs a second analysis of the same mass range of second sample 320 and generates results. Second set of multivariate data 321 that includes both retention time and mass spectral data is produced.

Processor 340 can be, but is not limited to, a controller, a computer, a microprocessor, the computer system of FIG. 1, or any device capable of analyzing data. Processor 340 can also be any device capable of sending and receiving control signals and data.

Processor 340 divides each of first set 311 and the second set 321 into two or more subsets corresponding to two or more m/z sub-ranges of the mass range. Finally, processor 340 aligns one or more chromatographic peaks in each of the two or more subsets of first set 311 with one or more chromatographic peaks in each corresponding subset of the two or more subsets of second set 321 using an alignment method.

In various embodiments, the mass spectral data of the first set and the mass spectral data of the second set include precursor ion mass spectral data.

In various embodiments, the mass spectral data of the first set and the mass spectral data of the second set include product ion mass spectral data.

In various embodiments, the first analysis and the second analysis are SWATH or DIA analyses. In both analyses, the same precursor ion mass transmission windows are used and the two or more m/z sub-ranges of the mass range are the precursor ion mass transmission windows.

In various embodiments, the first sample and the second sample are different samples. In various alternative embodiments, the first sample and the second sample are the same samples (or the second sample is a replicate of the first sample).

In various embodiments, the alignment method is a warping method. In various embodiments, the warping method is a dynamic time warping (DTW) method.

In various embodiments, separation coupled mass spectrometer 330 includes mass spectrometer 333 that measures mass data over time and sends this data to processor 340. Ion source device 332 of mass spectrometer 333 ionizes separated fragments of compounds of samples 310 and 320 or only compounds of samples 310 and 320, producing an ion beam. Ion source device 332 is controlled by processor 340, for example. Ion source device 332 is shown as a component of mass spectrometer 333. In various alternative embodiments, ion source device 332 is a separate device. Ion source device 332 can be, but is not limited to, an electrospray ion source (ESI) device or a chemical ionization (CI) source device such as an atmospheric pressure chemical ionization source (APCI) device or an atmospheric pressure photoionization (APPI) source device.

Mass spectrometer 333 mass analyzes product ions of compounds of samples 310 and 320 or selects and fragments compounds of samples 310 and 320 and mass analyzes product ions of the compounds of samples 310 and 320 from the ion beam at a plurality of different times. Mass spectrometer 333 is controlled by processor 340, for example.

In the system of FIG. 3, mass spectrometer 333 is shown as a triple quadrupole device. One of ordinary skill in the art can appreciate that any component of mass spectrometer 333 can include other types of mass spectrometry devices including, but not limited to, ion traps, orbitraps, time-of-flight (TOF) devices, ion mobility devices, or Fourier transform ion cyclotron resonance (FT-ICR) devices.

In various embodiments, the system of FIG. 3 further includes a separation device 331 that separates compounds from samples 310 and 320. As shown in FIG. 3, additional device 331 is an LC device. In various alternative embodiments, additional device 710 can be, but is not limited to, a gas chromatography (GC) device, capillary electrophoresis (CE) device, or an ion mobility spectrometry (IMS) device.

In various embodiments, the results generated from the separation coupled mass spectrometer may be stored and/or transferred to other systems so that the alignment procedure carried out in accordance with the teachings described herein can be carried out at a later time. In such cases, the results may be stored in a memory, which can be a random-access memory (RAM) or other dynamic storage device including a storage device, such as a magnetic disk or optical disk, or cloud based storage.

### Method for Aligning Chromatographic Peaks of Separate Experiments

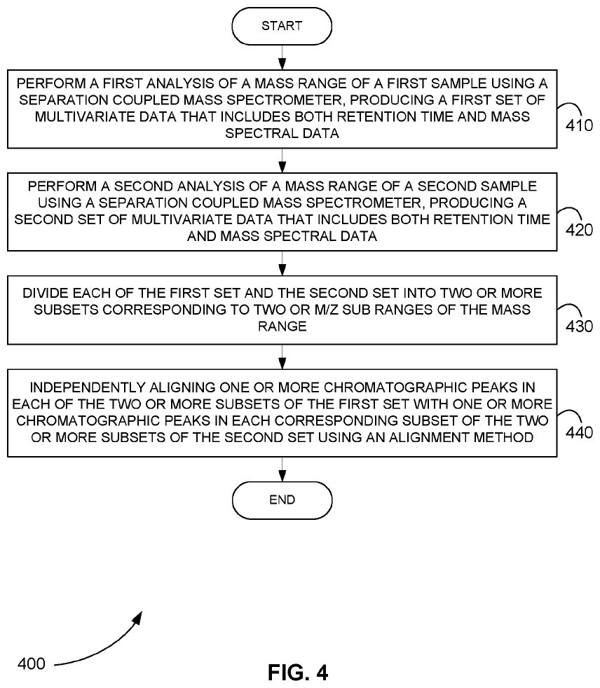

FIG. 4 is an exemplary flowchart showing a method 400 for aligning chromatographic peaks of separate experiments, in accordance with various embodiments.

In step 410 of method 400, a first analysis of a mass range of a first sample is performed using a separation coupled mass spectrometer, producing a first set of multivariate data that includes both retention time and mass spectral data.

In step 420, a second analysis of a mass range of a second sample is performed using a separation coupled mass spectrometer, producing a second set of multivariate data that includes both retention time and mass spectral data.

In step 430, each of the first set and the second set is divided into two or more subsets corresponding to two or m/z sub-ranges of the mass range.

In step 440, one or more chromatographic peaks in each of the two or more subsets of the first set are independently aligned with one or more chromatographic peaks in each corresponding subset of the two or more subsets of the second set using an alignment method.

### Computer Program Product for Aligning Chromatographic Peaks

In various embodiments, a computer program product includes a non-transitory tangible computer-readable storage medium whose contents include a program with instructions being executed on a processor so as to perform a method for aligning chromatographic peaks of separate experiments. This method is performed by a system that includes one or more distinct software modules.

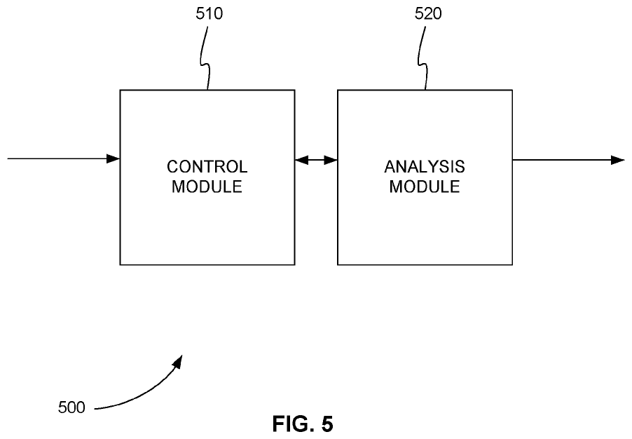

FIG. 5 is a schematic diagram of a system 500 that includes one or more distinct software modules and that performs a method for providing a user interface for aligning chromatographic peaks of separate experiments, in accordance with various embodiments. System 500 can include control module 510 and analysis module 520.

Control module 510 instructs a separation coupled mass spectrometer to perform a first analysis of a mass range of a first sample, producing a first set of multivariate data that includes both retention time and mass spectral data. Control module 510 instructs the separation coupled mass spectrometer to perform a second analysis of the mass range of a second sample, producing a second set of multivariate data that includes both retention time and mass spectral data. The results of the operation of the coupled mass spectrometer can be stored through various means and later obtained separately by the analysis module 520.

Analysis module 520 divides each of the first set and the second set into two or more subsets corresponding to two or more m/z sub-ranges of the mass range.

Analysis module 520 independently aligns one or more chromatographic peaks in each of the two or more subsets of the first set with one or more chromatographic peaks in each corresponding subset of the two or more subsets of the second set using an alignment method.

When the at least one interactive icon is selected, analysis module 910 displays in the same panel of the sequence and at the same time as the sequence at least two different spectral plots showing two different product ions of the at least one spectrum that support a cleavage of the bond.

In certain embodiments, the system can contain the control module alone or the analysis module alone. In certain embodiments, the procedures followed for the control module can be performed on a computer program product that is different from the computer program product used that performs procedures carried out by the analysis module. In some embodiments, acquiring the results of the first analysis of a mass range of a first sample and the second analysis of a mass range of a second sample can be performed separately and on a different computer program product from the analysis module that performs the alignment.

### Experimental Data

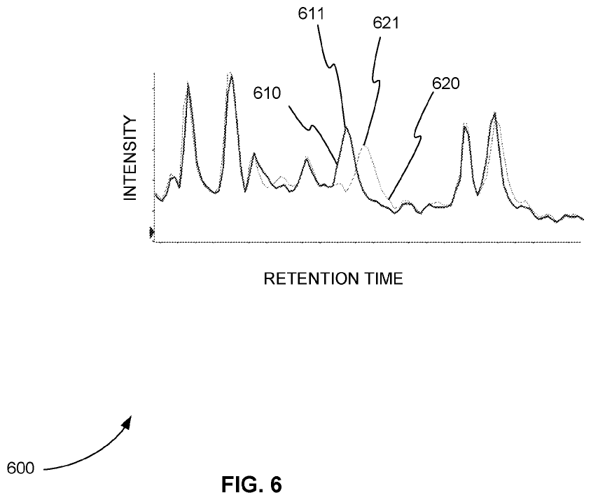

FIG. 6 is an exemplary plot 600 of the total ion chromatograms (TICs) from two replicate SWATH experiments without separating the multivariate data by SWATH before aligning the chromatographic peaks using the DTW method, in accordance with various embodiments. TIC 610 of plot 600 is for a first sample and TIC 620 is for a second sample. Plot 600 shows that even using the DTW method chromatographic peaks 611 and 621 of the replicate samples are misaligned.

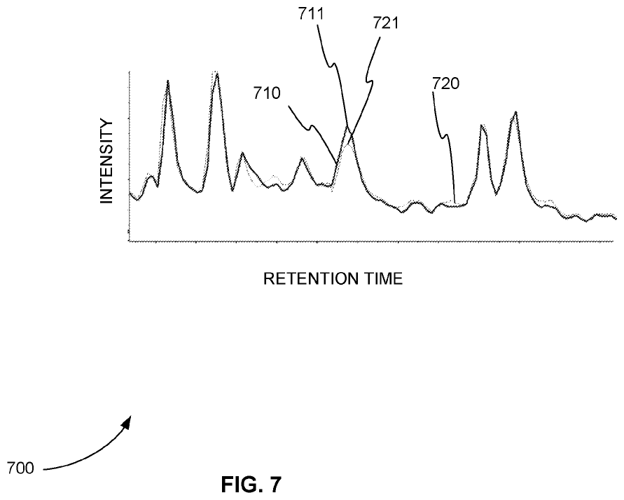

FIG. 7 is an exemplary plot 700 of the TICs from two replicate SWATH experiments where the multivariate data is separated by SWATH before aligning the chromatographic peaks using the DTW method, in accordance with various embodiments. TIC 710 of plot 700 is for a first sample and TIC 720 is for a second sample. Plot 700 shows that separating the multivariate data by SWATH before using the DTW method allows chromatographic peaks 711 and 721 of the replicate samples to now be aligned properly.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A method for aligning chromatographic peaks of separate experiments, comprising:
(a) obtaining results of a first analysis of a mass range of a first sample generated from a separation coupled mass spectrometer, producing a first set of multivariate data that includes both retention time and mass spectral data;
(b) obtaining results of a second analysis of the mass range of a second sample generated from the separation coupled mass spectrometer, producing a second set of multivariate data that includes both retention time and mass spectral data;
(c) dividing each of the first set and the second set into two or more subsets corresponding to two or more mass-to-charge (m/z) sub-ranges of the mass range; and
(d) independently aligning one or more chromatographic peaks in each of the two or more subsets of the first set with one or more chromatographic peaks in each corresponding subset of the two or more subsets of the second set using an alignment method.

2. The method of claim 1, wherein the mass spectral data of the first set and the mass spectral data of the second set comprise precursor ion mass spectral data.

3. The method of claim 1, wherein the mass spectral data of the first set and the mass spectral data of the second set comprise product ion mass spectral data.

4. The method of claim 1, wherein the first analysis and the second analysis comprise data independent acquisition (DIA) analyses with precursor ion mass transmission windows that are the same and the two or more m/z sub-ranges of the mass range comprise the precursor ion mass transmission windows.

5. The method of claim 1, wherein the first sample and the second sample comprise different samples.

6. The method of claim 1, wherein the alignment method comprises a warping method.

7. The method of claim 6, wherein the warping method comprises dynamic time warping (DTW).

8. A computer program product, comprising a non-transitory tangible computer-readable storage medium whose contents cause a processor to perform a method for aligning chromatographic peaks of separate experiments, comprising:
providing a system, wherein the system comprises one or more distinct software modules, and wherein the distinct software modules comprise an analysis module;
obtaining results of a first analysis of a mass range of a first sample using the analysis module, the results of the first analysis of the mass range having a first set of multivariate data that includes both retention time and mass spectral data;
obtaining results a second analysis of the mass range of a second sample using the analysis module, the results of the second analysis of the mass rang having a second set of multivariate data that includes both retention time and mass spectral data;
dividing each of the first set and the second set into two or more subsets corresponding to two or more mass-to-charge (m/z) sub-ranges of the mass range using the analysis module; and
independently aligning one or more chromatographic peaks in each of the two or more subsets of the first set with one or more chromatographic peaks in each corresponding subset of the two or more subsets of the second set using an alignment method using the analysis module.

9. The computer program product of claim 8, wherein the distinct software modules further comprises a control module and wherein the control module instructs a separation coupled mass spectrometer to perform the first analysis of a mass range of the first sample and the second analysis of a mass range of the second sample.

10. The computer program product of claim 8, wherein the mass spectral data of the first set and the mass spectral data of the second set comprise precursor ion mass spectral data.

11. The computer program product of claim 8, wherein the mass spectral data of the first set and the mass spectral data of the second set comprise product ion mass spectral data.

12. The computer program product of claim 8, wherein the first analysis and the second analysis comprise data independent acquisition (DIA) analyses with precursor ion mass transmission windows that are the same and the two or more m/z sub-ranges of the mass range comprise the precursor ion mass transmission windows.

13. The computer program product of claim 8, wherein the first sample and the second sample comprise different samples.

14. The computer program product of claim 8, wherein the alignment method comprises a warping method.

15. The computer program product of claim 14, wherein the warping method comprises dynamic time warping (DTW).

16. A system for identifying an unknown compound, comprising:
a processor that
obtains results of a first analysis of a mass range of a first sample, having a first set of multivariate data that includes both retention time and mass spectral data;
obtains results of a second analysis of the mass range of a second sample, having a second set of multivariate data that includes both retention time and mass spectral data;
divides each of the first set and the second set into two or more subsets corresponding to two or more mass-to-charge (m/z) sub-ranges of the mass range; and
independently aligns one or more chromatographic peaks in each of the two or more subsets of the first set with one or more chromatographic peaks in each corresponding subset of the two or more subsets of the second set using an alignment method.

17. The system of claim 16, further comprising a separation coupled mass spectrometer, wherein the separation coupled mass spectrometer performs the first analysis of a mass range of the first sample and the second analysis of a mass range of the second sample, and the results of the first analysis of a mass range of a first sample and the second analysis of a mass range of a second sample are obtained from the separation coupled mass spectrometer.
